(19) United States
(12) Patent Application Publication
(10) Pub. No.: US 2007/0292252 A1
(43) Pub. Date: Dec. 20, 2007

(54) APPARATUS FOR LIFTING AND MOVING A WORKLOAD

(76) Inventors: Dennis E. McGill, Edmond, OK (US); Billy J. Lucas, Luther, OK (US)

Correspondence Address: DUNLAP CODDING & ROGERS, P.C., PO BOX 16370, OKLAHOMA CITY, OK, 73113, US

(21) Appl. No.: 11/845,622

(22) Filed: Aug. 27, 2007

Related U.S. Application Data
(63) Continuation of application No. 10/650,372, filed on Aug. 28, 2003.
(63) Continuation-in-part of application No. 10/132,140, filed on Apr. 24, 2002, now abandoned.
Application No. 10/132,140 is a continuation of application No. 09/728,394, filed on Dec. 4, 2000, now Pat. No. 6,406,248.
(60) Provisional application No. 60/406,783, filed on Aug. 28, 2002.

(51) Int. Cl. B66F 9/08; B62B 3/00

(52) U.S. Cl. 414/634; 414/448

(57) ABSTRACT

A portable apparatus for moving a workload, comprising a base frame, a translation assembly, a non-telescoping mast, a tilting assembly, a lifting frame, and a hoist assembly. The translation assembly engages the base frame to facilitate movement of the base frame. The non-telescoping mast has a lower end pivotally engaging the base frame, an upper end, and a length extending between the lower end and the upper end. The tilting assembly engages the mast and the base frame to selectively adjust the incline of the mast relative to the base frame. The lifting frame operatively associated with the mast. The hoist assembly engaging the mast and the lifting frame for selectively lifting the lifting frame along at least a portion of the length of the mast.

### CROSS-REFERENCE TO RELATED APPLICATIONS

The present application claims priority under 35 U.S.C. 119 (e) to the Provisional Patent Application U.S. Ser. No. 60/406,783, which was filed on Aug. 28, 2002, the entire contents of which are hereby expressly incorporated herein by reference.

The present application is also a continuation of U.S. patent application Ser. No. 10/650,372, filed Aug. 28, 2003; which is a continuation-in-part of U.S. patent application Ser. No. 10/132,140, filed Apr. 24, 2002, now abandoned; which is a continuation of U.S. patent application Ser. No. 09/728,394, filed Dec. 4, 2000, now U.S. Pat. No. 6,406,248, issued Jun. 18, 2002, the entire contents of each being hereby expressly incorporated herein by reference.

### BACKGROUND

1. Field of the Invention

The present invention relates to a lifting apparatus and more particularly, to an apparatus capable of lifting numerous objects, such as a water heater, air conditioner, garage door, construction materials, etc.

The present invention eliminates the necessity of requiring the use of multiple individuals to move such objects. Through the use of the present invention, a mechanical apparatus which grasps, lifts, tilts, and translates the orientation of the object, such as the water heater is made efficient and safe.

2. Description of the Prior Art

Local codes usually require water heaters, particularly those installed in garages or the like, to have the base or bottom end of the heater elevated and supported on a stand at least 45.72 cm (18″) inches above the surface of the surrounding, and generally horizontal, floor. Since many of these water heaters are of considerable size, varying diametrically and longitudinally, and generally cylindrical, when a 189 L (50 gal) or greater volume water heater must be elevated it requires more than one workman to handle the water heater and lift it into place. Although water heaters are mentioned herein, the same issues regarding difficulty of movement are also applicable to numerous other objects including, but not limited to, air conditioning units, HVAC systems, and other bulky heavy objects.

The prior art discloses a number of United States patents which lift and move cylindrical containers from one location to another for example, U.S. Pat. No. 5,379,814 issued Jan. 10, 1995 to Posly for a “Water Bottle Lifting Mechanism”. The Posly patent discloses a mechanism which lifts a bottle of water from a lower upright position to an elevated position during which a cam mechanism rotates the water bottle from an upright position to an inverted water discharging position. Also, U.S. Pat. No. 5,618,154 issued Apr. 8, 1997 to Irons, Jr. et al. for a “Drum Transporter” discloses a main frame mounted on wheels supporting a mast assembly extending horizontally from the main frame. An outer mast assembly includes a pair of legs which diverge from each other for straddling a pallet supporting a drum to be moved. A post extends upwardly from the main frame and includes a fixed guide post having an upward clamping mechanism for releasably engaging a drum chime to support the drum on a lower drum lifting support permitting the lifting mechanism to lift and move the drum from one location to another and minimize a tendency of the transporter to tip the drum during the handling movement thereof.

U.S. Pat. No. 5,122,027 issued Jun. 16, 1992 to Tabayashi for a “Carrier For Containers” and U.S. Pat. No. 5,944,474 issued Aug. 31, 1999 to Cummins et al. for a “Support For A Cylindrical Container” are believed to be good examples of further state-of-the-art. The Tabayashi and Cummins patents generally disclose horizontal wheel supported base frames which support upright members for lifting cylindrical containers from one place to another.

### BRIEF DESCRIPTION OF THE SEVERAL VIEWS OF THE DRAWINGS

FIG. 1 is a perspective view of one embodiment of a portable apparatus constructed in accordance with the present invention and, shown by dash lines, a water heater being lifted by the portable apparatus.

FIG. 2 is a front view of an improved caster constructed in accordance with the present invention.

FIG. 3 is a perspective view of the portable apparatus of FIG. 1 with a hoist post.

FIG. 4 is a perspective view of another embodiment of a portable apparatus constructed in accordance with the present invention.

FIG. 5 is a perspective view of another embodiment of a portable apparatus constructed in accordance with the present invention.

FIG. 6 is a perspective view of another embodiment of a portable apparatus constructed in accordance with the present invention.

FIG. 7 is a side view of the portable apparatus depicted in FIG. 1, with the workload lifted and in a forward tilted position.

FIG. 8 is a perspective view of the portable apparatus depicted in FIG. 3, with the workload lifted.

FIG. 9 is a perspective view of another embodiment of a portable apparatus constructed in accordance with the present invention.

### DETAILED DESCRIPTION OF EXEMPLARY EMBODIMENTS

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

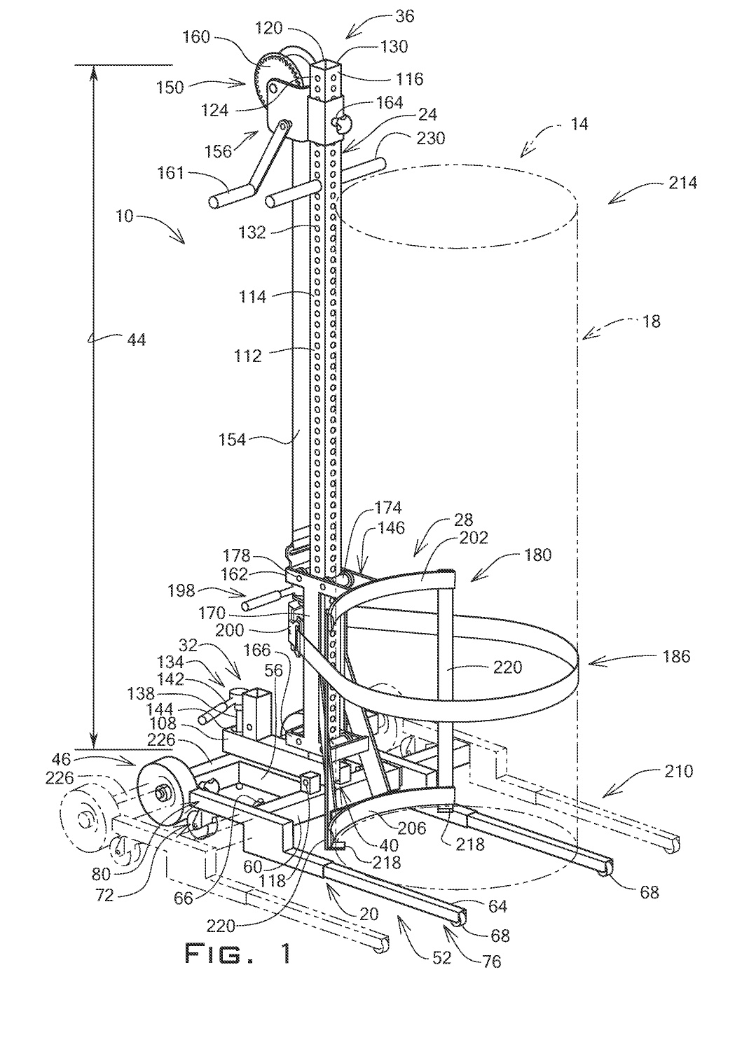

Referring now to the drawings, in particular to FIG. 1, shown therein and designated by the general reference numeral 10 is a portable apparatus constructed in accordance with the present invention. The portable apparatus 10 can be used to move a load or workload 14 (shown in phantom). The portable apparatus 10 can be used to support at least a portion of the workload 14, translate the workload 14 along a surface, lift the workload 14, lower the workload 14, and/or tilt the workload 14 so that the workload 14 can be transported to and deposited in a desired location in an efficient and easy manner. The workload 14 can be any weight, system, object, or mass, or any combination of weights, systems, objects, or masses, capable of being supported, moved, lifted, lowered, and/or tilted in accordance with the present invention as discussed in further detail below. In one preferred embodiment, as shown for example in FIG. 1, the workload 14 is a cylindrical container, such as a water heater 18.

The workload 14 will be described herein by way of example as the water heater 18. However, it should be understood that the portable apparatus 10 can be used for moving other types of loads, such as for example a garage door, an HVAC system, dry goods, shingles and other construction materials, etc. Also, although the workload 14 will be describe herein by way of example as one cylindrical water heater 18, it should be understood that the workload 14 can be a plurality of objects and can have any shape so long as the workload 14 can be supported, moved, lifted, lowered, and/or tilted by the portable apparatus 10 in accordance with the present invention.

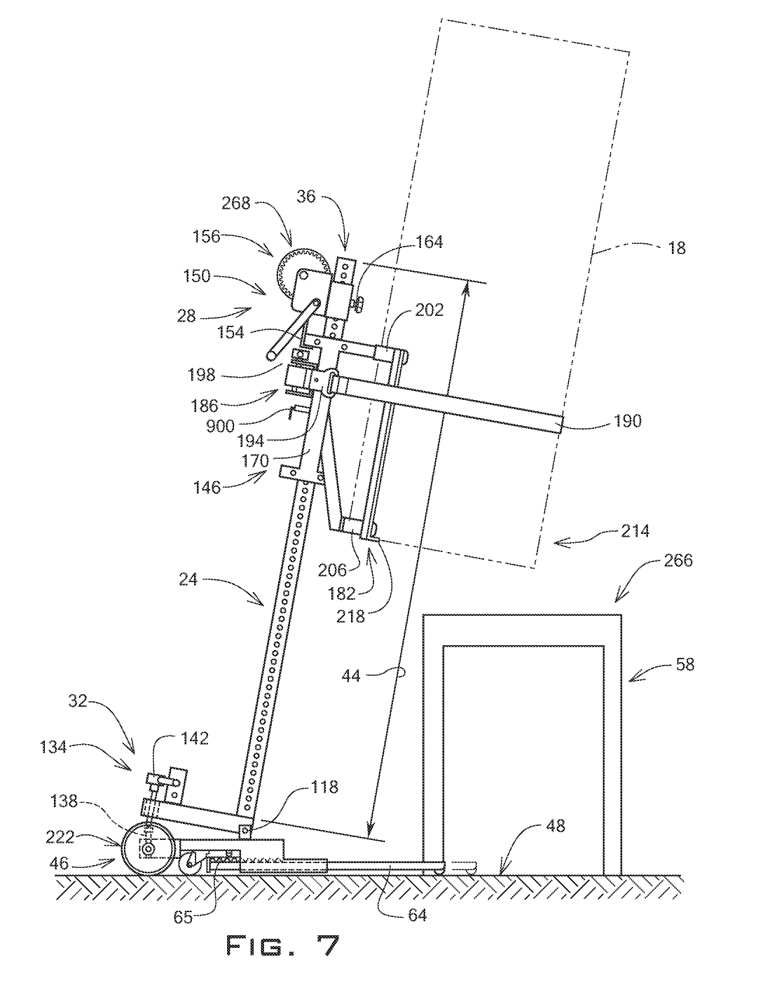

Generally, the portable apparatus 10 includes a base frame 20, a mast 24, a lifting assembly 28, and a tilting assembly 32. The mast 24 is supported by the base frame 20 and has a first end 36, a second end 40, and a length 44 extending therebetween. The length 44 of the mast 24 may be of any dimension. Indeed, the mast 24 may be composed of one or more submasts (not shown) that are connected to one another to form mast 24 having a length 44. The lifting assembly 28 lifts the water heater 18 along at least a portion of the length 44 of the mast 28. The tilting assembly 32 adjusts an incline of the mast 28 so that the mast 24, and thus the water heater 18, can be tilted (e.g. see FIG. 7 showing the mast 24 in an inclined state). Further, the base frame 20 of the portable apparatus 10 may also include a translation assembly 46 which is adapted to facilitate movement of the portable apparatus 10 along a surface 48 (see FIG. 7) such as, for example, a floor.

In general, the base frame 20 provides support for the portable apparatus 10 on the surface 48 and stabilizes the portable apparatus 10 on the surface 48 as the water heater 18 is lifted by the portable apparatus 10 and/or as the mast 24 of the portable apparatus 10 is tilted so as to incline the mast 24. In one preferred embodiment, as shown for example in FIG. 1, the base frame 20 has an expandable portion 52 and a bight portion 56. The expandable portion 52 is adapted to allow for expansion of the base frame 20 so that the base frame 20 can be adjusted to allow for more efficient weight distribution of the portable apparatus 10 on the surface 48 so as to further stabilize the portable apparatus 10 on the surface 48, especially when the portable apparatus 10 is lifting the water heater 18 and/or the mast 24 of the portable apparatus 10 tilted so as to incline the mast 24. Also, the adjustable expansion of the expandable portion 52 allows the base frame 20 to be adapted according to a surrounding environment. For example, if the water heater 18 is to be placed onto an immovable object, such as a stand 58 (see FIG. 7), then the adjustable portion 52 can be adjusted to envelope opposing sides of the immovable object when positioning the water heater 18 on the immovable object. The bight portion 56 engages the expandable portion 52 and connects to the mast 24 so as to centrally support the mast 24 to the portable apparatus 10.

In one preferred embodiment, the expandable portion 52 of the portable apparatus includes at least one telescoping cross member 60 and a plurality of telescoping legs 64 connected to the telescoping cross member 60. In one preferred embodiment, the expandable portion 52 has two telescoping legs 64 connected to the telescoping cross member 60 in a generally U-shaped configuration. Although the expandable portion 52 is shown in FIG. 1 as having only one telescoping cross member 60 and two telescoping legs 64, it should be understood that the expandable portion 52 may have any number of telescoping cross members 60 and corresponding telescoping legs 64.

The telescoping cross member 60 is adapted to longitudinally expand inwardly and outwardly from the base frame 20 and is, more particularly, connected to the bight portion 56 of the base frame 20. Each of the telescoping legs 64 is adapted to longitudinally expand inwardly and outwardly and connect to the telescoping cross member 60 so as to allow for two-dimensional expansion of the base frame 20. In one preferred embodiment, once the telescoping cross member 60 is expanded to a desired position, the telescoping cross member 60 can be locked into place via a locking assembly 66. The locking assembly 66 can be provided with a knob, for example, in order to facilitate turning of the locking assembly 66 so as to secure the telescoping cross member 60 in place.

In one preferred embodiment, the telescoping legs 64 are connected to the telescoping cross member 60 via a weld (not shown). However, it should be understood the telescoping legs 64 and the telescoping cross member can be connected by any means, such as for example welding, bonding, bolting, screwing, gluing, clamping, fastening, magnetizing, interlocking, or engaging spring means or any other means known in the art. Further, the connection can be permanent i.e. the telescoping legs 64 may be fixed permanently in place.

In one embodiment, each of the telescoping legs 64 has at least one forward wheel 68 and at least one caster 72 connected to the telescoping leg 64 to facilitate expansion of expandable portion 52 generally along the surface 48. Preferably, the forward wheel 68 is rotatably connected near a forward end 76 of the telescoping leg 64 and the at least one caster 72 is rotatably connected near a rearward end 80 of the telescoping leg 64. As shown in FIG. 7, the telescoping leg 64 is biased with a spring 65 to allow the telescoping leg 64 to move (shown in phantom) from an outwardly extended position to a compressed position. In one preferred embodiment, the at least one caster 72 is capable of rotating about at least two axes of rotation thereby facilitating the two dimensional expansion of the expandable portion 52.

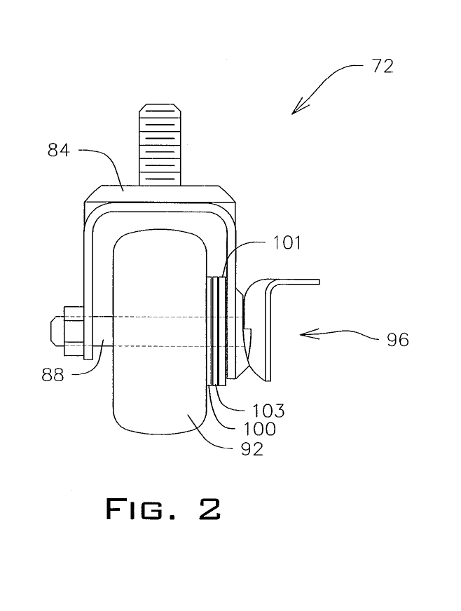

As best shown in FIG. 2, in order to allow the caster 72 to be rotatable about two axes of rotation, the caster 72 can include a swivel 84 rotatably connectable to the telescoping leg 64, an axle 88 engaging the swivel 84, and a caster wheel 92 rotatably connected to the axle 88 such that the caster wheel 92 is capable of revolving about the axle 88. The caster 72 can also be provided with a locking assembly 96 adapted to engage the caster wheel 92 so as to substantially impede the revolution of the caster wheel 92 about the axle 88 when the locking mechanism 96 is in a locked position. Further, the locking assembly 96 and the caster 72 may also include a first resistance disk 100 attached to the axle 88 of the caster wheel 92 and a second resistance disk 101 attached to the swivel 84 and a stopping material 103 disposed between the first, second resistance disks 100, 101, respectively. The stopping material 103 may be for example a typical brake pad material or felt. Whereby the second disk 101 cooperates with the locking assembly 96 to further impede the revolution of the caster wheel 92 on the axle 88 when the locking assembly 96 is in the locked position by adding additional friction against the first resistance disk 100 when the locking assembly 96 is in the locked position. Each of the plurality of resistance disks 100 can be for example a washer made of any material having a coefficient of friction sufficient to engage and hold the caster wheel 92 in a substantially immovable position wherein each resistance disk 100 is disposed on the axle 88 adjacent to the caster wheel 92.

Generally, the mast 24 of the portable apparatus 10 provides a guide along which the lifting assembly 28 lifts the water heater 18. The mast 24 is preferably connected to the base frame 20 such that the mast 24 is capable of being inclined with respect to a substantial portion of the base frame 20 and/or the surface 48. The incline of the mast 24 allows for the water heater 18 supported by the lifting assembly 28, as discussed in further detail below, to be tilted.

In one preferred embodiment, the mast 24 is L-shaped and has a foot portion 108 and an elongated member 112. The foot portion 108 connects to the base frame 20 and the elongated member 112 connects to the foot portion 108. In one preferred embodiment, the elongated member 112 is removably connected to the foot portion 108, for example via a removable pin 118, so that the elongated member 112 can be removed from the foot portion 108, for example for storage or shipment of the portable apparatus 10. However, although the foot portion 108 is describe above as being connected to the elongated member 112 via the removable pin 118, it should be understood that the foot portion 108 and the elongated member 112 can be connected by any means, such as for example welding, bonding, bolting, screwing, gluing, clamping, fastening, magnetizing or any other means known in the art. Further, the connection can also be permanent or adjustable.

In one preferred embodiment, the elongated member 112 includes at least one piece of box channel tubing 114 so as to provide the elongated member 112 of the mast 24 with a forward surface 116, a rearward surface 120, a first side surface 124, and a second side surface 130. The rearward surface 120 is oppositely disposed of the forward surface 116. The first side surface extends generally from the forward surface 116 to the rearward surface 120, and the second side surface 130 is oppositely disposed of the first side surface and extends generally from the forward surface 116 to the rearward surface 120. Further, the mast 24 can have a plurality of holes 132 therethrough, which may or may not be threaded, which can be used to facilitate connections made with the mast 24, for example by allowing pins, bolts, or screws to be disposed through the holes 132. For example, the holes 132 can be keyhole slots in at least one of the forward surface 116, rearward surface 120, first side surface 124, second side surface 130, or combinations thereof, of the elongated member 112 of the mast 24.

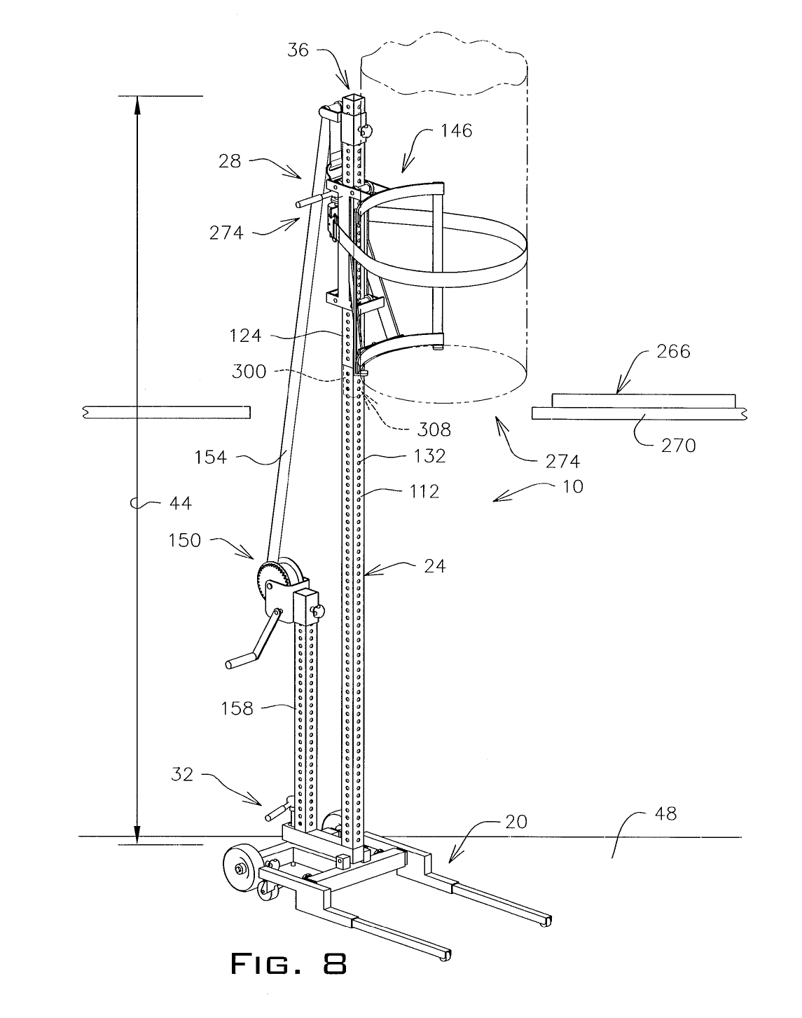

In another embodiment of the present invention, as shown for example in FIG. 8, the mast can also include an extension member 124 telescopically disposed in the elongated member 112 such that the extension member 124 is extendable from the elongated member 112. The extension member 124 effectively increases the length 44 of the mast 24.

In one preferred embodiment, to adjust the incline of the mast 24 the foot portion 108 can be hingably connected to the base frame 20 so that the mast 24 can pivot with respect to the base frame 20. In one preferred embodiment, the tilting assembly 32 pivots the mast 24 in a forward tilting position (see FIG. 7). The tilting assembly 32 can then adjust the incline of the mast 24 by pivoting the mast 24 forward. The tilting assembly 32 can be any device capable of pivoting the mast 24. For example, the tilting assembly 32 can include a mechanical jack or lift, which may be operated manually or automated, for example by using pressurized air, hydraulics, or a motor. In one embodiment, shown for example in FIG. 7, the tilting assembly 32 includes a screw jack assembly 134 having a screw 138 and screw jack handle 142. The screw jack handle 142 may be removable in one embodiment. In one embodiment, the screw 138 threadingly engages the bight portion 56 of the base frame 20 and anchors to the foot portion 108 of the mast 24 such that when the screw 138 is rotated in one direction via the screw jack handle 142, the screw jack assembly 134 causes the foot portion 108, and thus the elongated member 112 attached thereto, to pivot with respect to the base frame 20, thereby adjusting the incline of the mast 24. In another embodiment, the screw 138 is threaded with left and right acme threads. The portion of the screw 138 that engages the foot portion 108 is threaded with right handed acme threads while the portion of the screw 138 that engages the base frame 20 is threaded with left handed acme threads. In one embodiment, the foot portion 108 of the mast has an open slot 144 for receiving the screw 138. The manual angular rotation of the screw jack handle 142 in one direction rotates the screw 138 which, in turn, engages left and right hand acme threads (not shown) disposed in the open slot 144. The screw jack handle 142 can be any device capable of rotating the screw 138, such as for example a ratchet, knob, or screwdriver.

In one preferred embodiment, to move the water heater 18 generally along at least a portion of the length 44 of the mast 24, the lifting assembly 28 of the portable apparatus 10 is provided with a lifting frame 146 and a hoist assembly 150. In general, the lifting frame 146 supports at least a portion of the water heater 18 and the hoist assembly 150 engages lifting frame 146 and traverses the lifting frame 146, and thus the attached water heater 18, generally along at least a portion of the length 44 of the mast 24. In one preferred embodiment, the lifting frame 146 is longitudinally and reciprocatably traverseable on the mast 24 so that the lifting frame 146 is capable of moving along at least a portion of the length 44 of the mast 24 generally toward or away from both the first end 36 and second end 40 of the mast 24, i.e., the lifting frame 146, and thus the water heater 18 supported by the lifting frame 146, can be raised or lowered along and relative to the mast 24. As shown in FIG. 7, the lifting frame 146 may also include a biased holding assembly 900 which springly engages the holes 132 as the lifting frame 146 is raised upwardly along the mast 24. The biased holding assembly 900 may also be placed in a configuration such that it does not engage the holes 132 so that the lifting frame 146 can be quickly lowered down the mast 24.

The hoist assembly 150 can be any device capable of traversing the lifting frame 146 and water heater 18 generally along the mast 24. For example, the hoist assembly 150 can include a mechanical jack or lift, which may be operated manually or automated, for example by using pressurized air, hydraulics, or a motor. In one embodiment, in order to traverse the lifting frame 146 generally along the mast 24, the hoist assembly 150 engages the lifting frame 146 via a flexible band or belt 154 which can be retracted or advanced to cause the lifting frame 146 to traverse generally along and relative to the mast 24. For example, the hoist assembly 150 can include a hand crank winch 158 which retracts or advances the flexible belt 154 by winding or unwinding the flexible belt 154 about a hoist drum 160 of the hand crank winch 158 by turning a crank arm 161 associated with the hoist drum 160 to cause the angular rotation of the hoist drum 160, for example via a gear connection (not shown). The flexible belt 154 can for example be a strap, rope, chain, cable, cord, interlocking keys (plastic or metal) or any other flexible material known in the art, or combinations thereof.

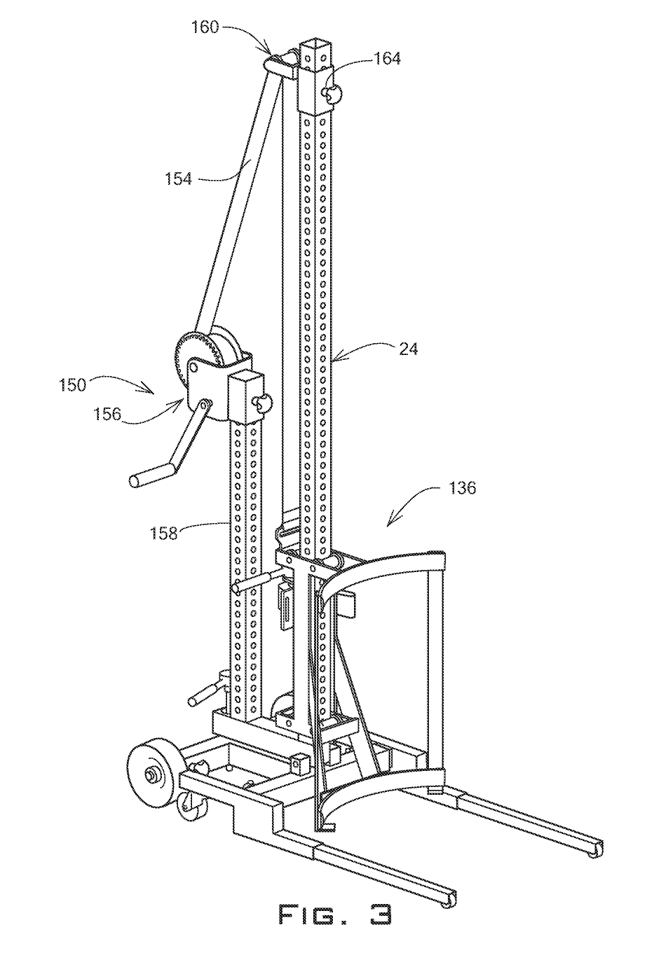

In one embodiment, the hoist assembly 150 is connected to the elongated member 112 of the mast 24 of the portable apparatus 10, preferably in a removable or adjustable manner. For example, when the mast 24 includes at least one piece of box channel tubing 114 with holes 132 therethrough, the hoist assembly 150 can be removably mounted onto the mast 24 with at least one mounting bolt 164. In one preferred embodiment, the hoist assembly 150 is connected generally near the first end 36 of the mast 24 so that the hoist assembly 150 does not interfere with the lifting frame 146 and/or water heater 18 as the lifting frame 146 and/or water heater 18 traverses generally along at least a portion of the length 44 of the mast 24. In another embodiment, when the water heater 18 is to be lifted along a substantial portion of the length 44 of the mast 24, the portable apparatus 10 can further be provided with a hoist post 158, as shown in FIG. 3. In one preferred embodiment, the hoist post 158, disposed generally adjacent to the mast 24 so that the hoist assembly 150 can be connected, preferably removable or adjustably, to the hoist post 158 whereby the hoist assembly 150 traverses the lifting frame 136 along at least a portion of the length 44 of the mast 24. For example, when the hoist assembly 150 includes the hand crank winch 156 which retracts or advances the flexible belt 154, the hoist assembly 150 can further include a spindle 160 or wheel (not shown) connected near the first end 36 of the mast 24 along which the flexible belt 154 traverses so as to provide a pulley system for the hoist assembly 150. Further, the hoist assembly 150 can be disposed independent of the mast 24 or the hoist post 158. For example, the hoist assembly 150 can be disposed on the surface 48, or another surface, such as for example a wall or a piece of equipment (not shown).

In one preferred embodiment, the lifting frame 146 has an upper arm 162 and a lower arm 166 cooperating to support at least a portion of the water heater 18 and a brace member 170 connecting the upper arm 162 and lower arm 166 in a generally vertically spaced relation. So that the lifting frame 146 is traversable along at least a portion of the length 44 of the mast 24, the brace member 170 can be provided with a plurality of guide bearings 174 (only one such guide bearing 174 being numbered for purposes of clarity) rotatably engaging the mast 24. In one preferred embodiment, the brace member 170 comprises two pair of guide bearings 174, with each such pair of guide bearings 174 journaling about a stub axle 178 (only one stub axle 178 being numbered for purposes of clarity) connected to the brace member 170. In one embodiment, the brace member 170 straddles the first side surface 124 and second side surface 130 of the elongated member 112 of the mast 24 and is in a slidable relation with respect to the forward surface 116 and rearward surface 120 of the elongated member 112 of the mast 24.

The lifting frame 146 of the portable apparatus 10 is provide with a platform 182 to support at least a portion of the water heater 18, or other workload 14, so that water heater 18 can be moved by the portable apparatus 10 in a more effective and safe manner. The platform 182 is connected to at least one of the upper arm 162, the lower arm 166, the brace member 170, or combinations thereof. The connection of the platform 182 to the upper arm 162, lower arm 166, and/or brace member 170 is preferably removable so that different embodiments of the platform 182, as discussed in further detail below, can be interchanged. For example, the platform 182 can be removably screwed to at least one of the upper arm 162 and/or lower arm 166. This allows for the platform 182 to be provided accordingly or more suitably for the particular shape of the workload 14 and/or the location in which the workload 14 is to be moved. However, it should be understood that the connection of the platform 182 to the upper arm 162, lower arm 166, and/or brace member 170 can also be permanent or adjustable.

The platform 182 is adapted to support at least a portion of the water heater 18, or other workload 14, and cooperates with at least one of the upper arm 162, the lower arm 166, the brace member 170, or combinations thereof to lift the water heater 18, or other workload 14, along at least a portion of the length 44 of the mast 24 as the lifting frame 146 is traversed generally along at least a portion of the length 44 of the mast 24.

The lifting frame 146 may further include a strapping mechanism 186 for securing at least a portion of the water heater 18, or other workload 14, to at least a portion of the lifting frame 146, preferably to the platform 182. In one preferred embodiment, the strapping mechanism 186 includes a flexible band 190 capable of being disposed generally about at least a portion of the water heater 18. The flexible band 190 can be for example a strap, rope, chain, cable, cord, or any other flexible material known in the art, or combinations thereof. The strapping mechanism 186 can further include a tightening assembly 198 which retracts and advances the flexible band 190 so as to secure the flexible band 190 about at least a portion of the water heater 18, or other workload 14. For example, the tightening assembly 198 can be a ratchet tie down band clamp. In one preferred embodiment, the tightening assembly 198 is connected to the brace member 170 of the lifting frame 146 to secure the flexible band 190, and thus the water heater 18, or other workload 14, to at least a portion of the lifting frame 144.

In one preferred embodiment, the flexible band 190 can be provided with a fastening end 200 connected to a free end of the flexible band 190. The fastening end 200 is preferably releasably connectable to at least one portion of at least one of the water heater 18 (or other workload 14), the lifting frame 146, the strap 190, the tightening assembly 198, or combinations thereof. The fastening end 200 can include any fastener, or combination of fasteners, such as for example a hook, tie, velcro.

In one embodiment, as shown in FIG. 1, the platform 182 can have a first arched portion 202 connected to the upper arm 162 of the lifting frame 144 and a second arched portion 206 connected to the lower arm 166 of the lifting frame 144. The first arched portion 202 supports at least a portion of a first end 210 of the water heater 18 and the second arched portion 206 supports at least a portion of a second end 214 of the water heater 18. The first arched portion 202 and second arched portion 204 have a part-circular curvature such that the platform 182 is particularly suitable for supporting a substantially cylindrically shaped workload 14, such as the water heater 18. The platform 182 can further have at least one supporting lip 218 cooperating with the second arched portion 206 to further support at least a portion of the second end 214 of the water heater 18. In one preferred embodiment, the platform 182 has two supporting lips 218 extending radially from the second arched portion 206. To further support the water heater 18, the platform 182 can also include at least one support rail 220 connecting the first arched portion 202 and the second arched portion 206 in a generally vertically spaced relation. In one preferred embodiment, the platform 182 has two support rails 220.

As discussed above, the base frame 20 of the portable apparatus 10 can further include the translation assembly 46 to facilitate movement of the portable apparatus 10, and any water heater 18, or other workload 14, supported by the portable apparatus 10, along the surface 48. In one preferred embodiment, the translation assembly 46 includes a plurality of translation wheels 222 which are in contact with the surface 48 when the portable apparatus 10 is tilted rearwardly. This allows the portable apparatus 10 to be wheeled along the surface 48 in a dolly fashion from one location to another, either alone or while supporting the water heater 18.

In such an embodiment, the translation assembly 46 can include at least two axle housings 226 (as shown by dashed lines in FIG. 1, only one axle housing numbered for purposes of clarity) telescopically disposed in the bight portion 56 of the base frame 20 such that the at least two axle housings 226 longitudinally expand inwardly and outwardly from the bight portion 56 of the base frame 20, and at least two translation wheels 222, wherein at least one of the at least two translation wheels 222 is rotatably connected via an axle 228 to at least one of the at least two axle housings 226. The telescoping housing 226 can expand inwardly and outwardly to adjust the spaced relation and position of the translation wheels 222 on the surface 48 to support and stabilize the portable apparatus 10, and any water heater 18 supported by the portable apparatus 10, on the surface 48 when the portable apparatus 10 is wheeled along on the translation assembly 46. The translation assembly 46 can further include at least one handle 230 so as to provide an appendage which can provide leverage for tilting the portable apparatus 10 rearwardly and/or for pushing and steering the portable apparatus 10 when moving the portable apparatus 10 along the surface 48. In one preferred embodiment, the handle 230 projects from the first side surface 124 and the second side surface 130 of the elongated member 112 of the mast 24 of the portable apparatus 10. Further, the handle 230 can be connected generally near the first end 36 of the mast 24 so that the handle 230 does not substantially interfere with the lifting frame 146 as the lifting frame 146 traverses generally along at least a portion of the length 44 of the mast 24.

In one preferred embodiment, the handle 230 is removably connected to elongated member 112 of the mast 24 so that the handle 230 can be removed and/or repositioned on elongated member 112 of the mast 24. For example, the handle 230 can be connected to the elongated member 112 via spring urged pins (not shown) supported by the extension member 124 which engage the holes 132 to lock the extension member 124 in axial alignment with the elongated member 112. However, the handle 230 can also be permanently or adjustably connected to the mast 24.

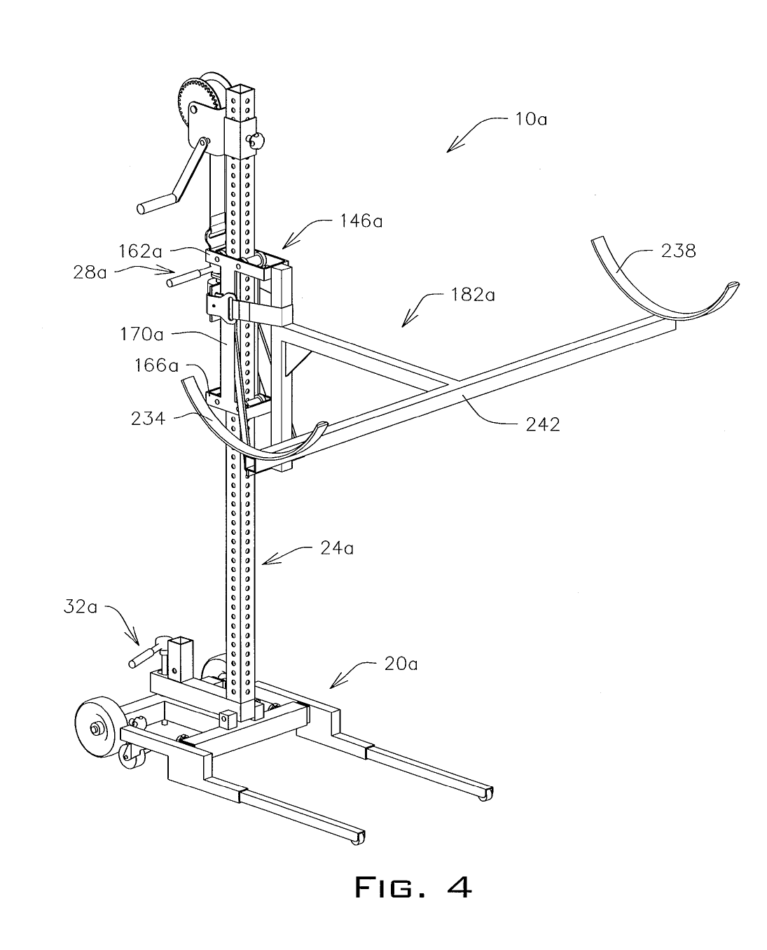

Referring now to FIG. 4, shown therein is a portable apparatus 10a constructed in accordance with the present invention. The portable apparatus 10a has a base frame 20a, a mast 24a, a lifting assembly 28a, and a tilting assembly 32a. The components in FIG. 4 include the same number prefix, but different alphabetic suffixes as the components in FIG. 1, to indicate that such components are similar. That is, the portable apparatus 10a is constructed and operated similarly as the portable apparatus 10, discussed hereinbefore with reference to FIG. 1, except that the lifting assembly 28a of the portable apparatus 10a has a platform 182a having a first cradle 234, a second cradle 238, and a cradle support frame 242.

The first cradle 234 supports at least a portion of the first end 210 of the water heater 18, or other workload 14, and the second cradle 238 supports at least a portion of the second end 214 of the water heater 18, or other workload 14. The cradle support frame 238 connects to at least one of an upper arm 162a, a lower arm 166a, a brace member 170a or combinations thereof, of a lifting frame 146a of the lifting assembly 28a and connects the first cradle 234 and the second cradle 238 in a generally horizontal spaced relation. The platform 10a allows for the portable apparatus 10a to support the water heater 18, or other workload 14, when the water heater 18, or other workload 14, is generally horizontal or has a substantial generally horizontal component.

The portable apparatus 10a may be, in alternate embodiments, especially well suited for lifting garage doors, tree limbs, etc. If first cradle 23f and second cradle 238 were straightened and made substantially parallel to the floor, the portable apparatus 10a would be especially well suited for lifting sheet materials such as drywall and plywood.

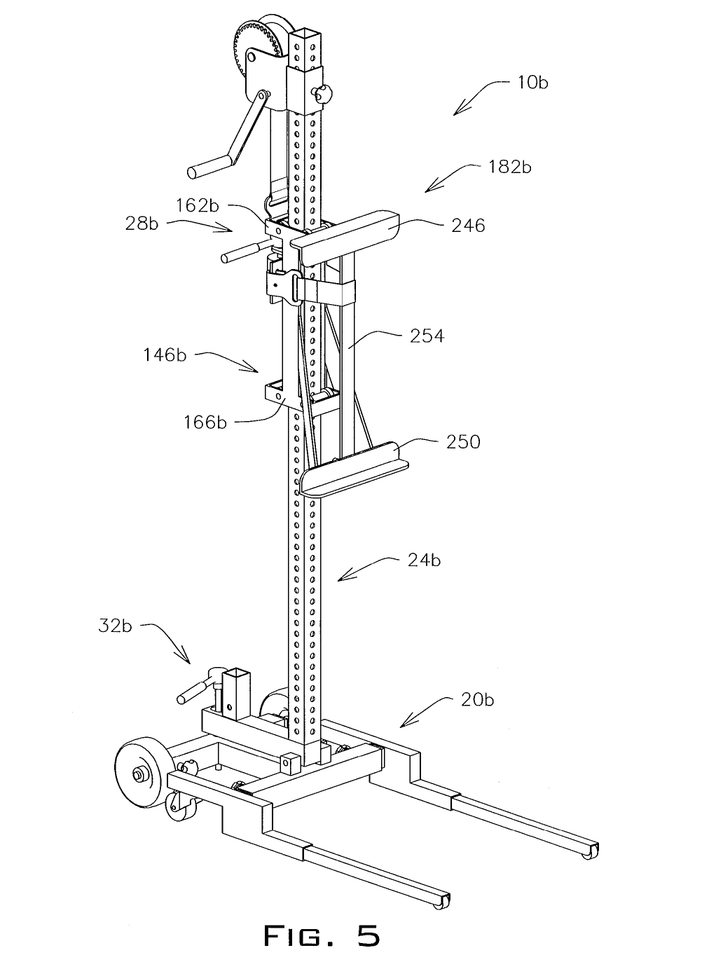

Referring now to FIG. 5, shown therein is a portable apparatus 10b constructed in accordance with the present invention. The portable apparatus 10b has a base frame 20b, a mast 24b, a lifting assembly 28b, and a tilting assembly 32b. The components in FIG. 5 include the same number prefix, but different alphabetic suffixes as the components in FIG. 1, to indicate that such components are similar. That is, the portable apparatus 10b is constructed and operated similarly as the portable apparatus 10, discussed hereinbefore with reference to FIG. 1, except that the lifting assembly 28b of the portable apparatus 10b has a platform 182b having an upper brace 246 and a lower brace 250.

The upper brace 246 of the platform 182b connects to an upper arm 162b of a lifting frame 146b of the lifting assembly 28b and supports at least a portion of the first end 210 the water heater 18, or other workload 14. The lower brace 250 of the platform 182b connects to a lower arm 166b of the lifting frame 146b of the lifting assembly 28b and supports at least a portion of the second end 214 of the water heater 18, or other workload 14. The platform 182b can further have at least one brace crossbeam 254 connecting the upper brace 246 and the lower brace 250 in a generally vertically spaced relation.

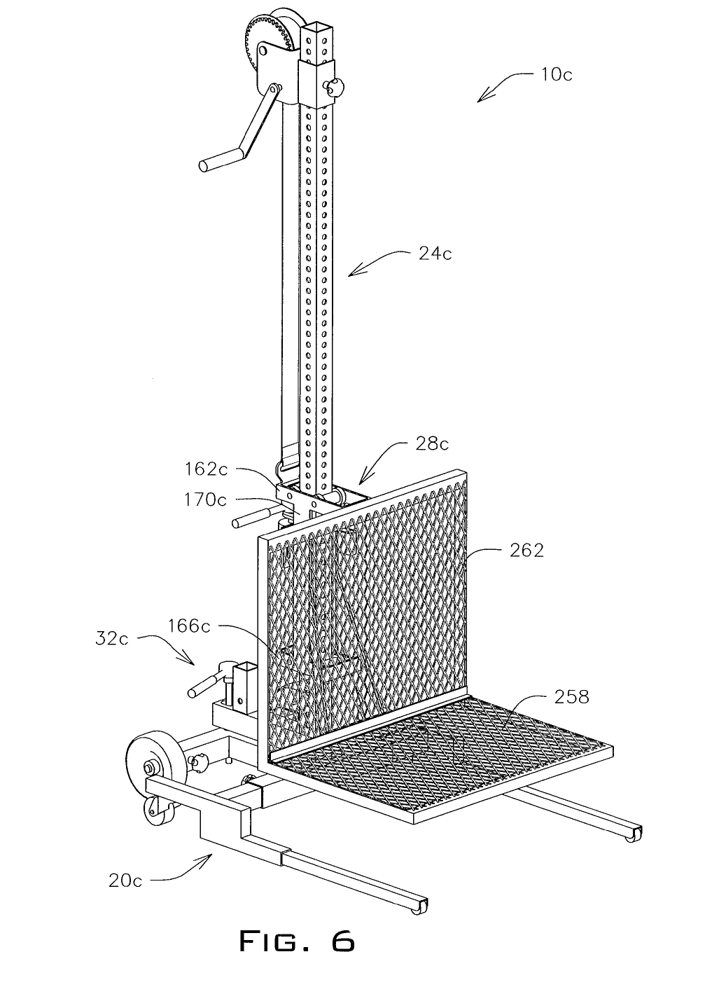

Referring now to FIG. 6, shown therein is a portable apparatus 10c constructed in accordance with the present invention. The portable apparatus 10c has a base frame 20c, a mast 24c, a lifting assembly 28c, and a tilting assembly 32c. The components in FIG. 6 include the same number prefix, but different alphabetic suffixes as the components in FIG. 1, to indicate that such components are similar. That is, the portable apparatus 10c is constructed and operated similarly as the portable apparatus 10, discussed hereinbefore with reference to FIG. 1, except that the lifting assembly 28c of the portable apparatus 10c has a platform 182c having a bottom plane member 258 and at least one side plane member 262.

The bottom plane member 258 supports at least a portion of the second end 214 of the water heater 18, or other workload 14. The at least one side plane member 262 connects to the bottom plane member 258 and supports to at least one portion of the first end 210 of the water heater 18, or other workload 14, the second end 214 of the water heater 18, or other workload 14, or combinations thereof. In one preferred embodiment, the side plane member 262 connects to the bottom plane member 258 orthogonally and is generally adjacent to an upper arm 162c and a lower arm 166c of a lifting frame 146c of the lifting assembly 28c. At least one of the bottom plane member 258, the side plane member 262, or combinations thereof is connected to at least one of the upper arm 162c, the lower arm 166c, the brace member 170, or combinations thereof. Further, although the platform 182c is shown as having only one side plane member 262 connected to the bottom plane member 258, the platform 182c can have more than one side plane member 232. For example, the platform 182 can have three or four side plane members 232 connected to the bottom plane member 258 so as to form a cage or box-like support for the water heater 18.

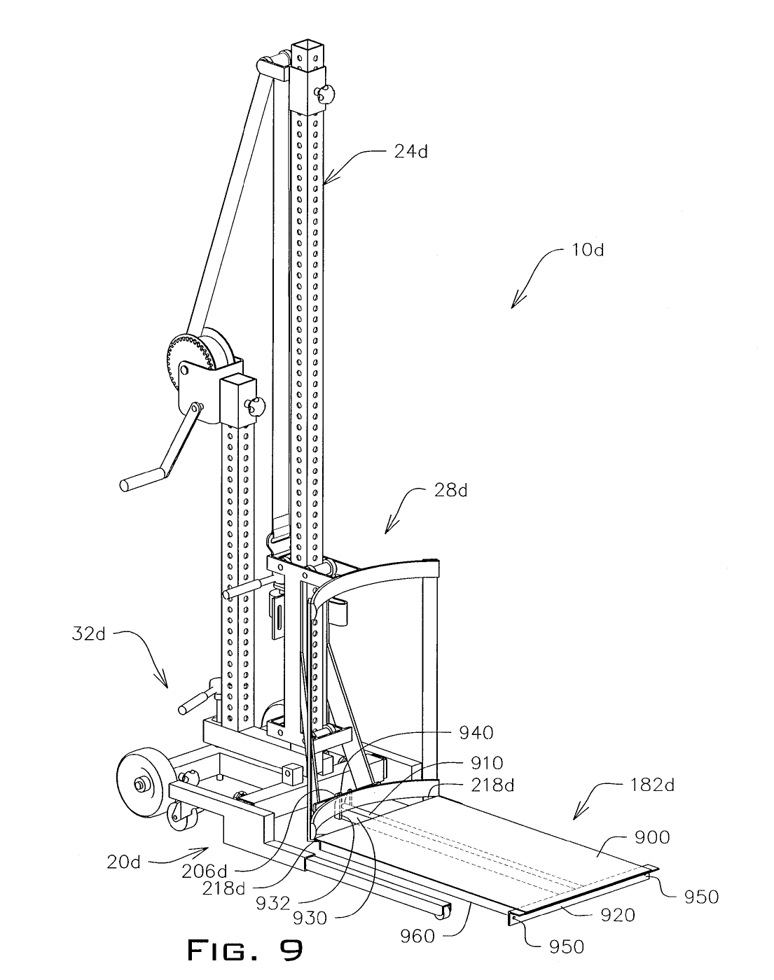

Referring now to FIG. 9, shown therein is a portable apparatus 10d constructed in accordance with the present invention. The portable apparatus 10d has a base frame 20d, a mast 24d, a lifting assembly 28d, and a tilting assembly 32d. The components in FIG. 9 include the same number prefix, but different alphabetic suffixes as the components in FIG. 1, to indicate that such components are similar. That is, the portable apparatus 10d is constructed and operated similarly as the portable apparatus 10, discussed hereinbefore with respect to FIG. 1, except that the lifting assembly 28d of the portable apparatus 10d has a platform 182d having a bottom plane member 900, a connection assembly 910, and a securing assembly 920.

The bottom plane member 900 supports at least a portion of the second end 214 of the water heater 18, or other workload 14. The connection assembly 910 reversibly secures that bottom plane member 900 to the lifting assembly 28d. In one preferred embodiment, the connection assembly 910 further includes a horizontal member 930 having a first end 932, and a catch assembly 940, wherein the catch assembly 940 is attached to and extends substantially perpendicularly upward from the first end 932 of the horizontal member 930. In operation, the catch assembly 940 engages the second arch support 206d and a bottom surface 960 of the bottom plane member 900 contacts and rests upon the two supporting lips 218d.

The securing assembly 920 is a substantially “L” shaped channel of material associated with the plane member 900. The securing assembly 920 includes a plurality of connection holes 950 through which a screw or other fastening device (not shown) may reversibly pass. The screw or other fastening device, in operation, passes through the plurality of connection holes 950 and reversibly engages a substrate, such as a sidewall of a platform, so as to reversibly attach the plane member 900 to the substrate.

### Operation

An example of the operation and use of the present invention will be described hereinafter in conjunction with the portable apparatus 10. However, it should be understood that the present invention operates in a similar manner with the portable apparatus 10a-10c. Further, the following example should be considered illustrative and not limiting the scope of the present invention. Other operations and uses of the present invention are apparent to one of ordinary skill in the art in view of the present disclosure.

In one example of operation, assuming the portable apparatus 10 has been constructed and assembled as described hereinabove, the portable apparatus 10 is manually moved over the surface 48, such as a floor, to the location of the water heater 18, to be lifted. The telescoping cross member 60 and the telescoping legs 64 of the base frame 20 can be expanded and disposed on opposing sides of the water heater 18 such that the telescoping legs 64 are straddling the water heater 18.

The lifting frame 146 of the portable apparatus 10 can be lowered such that the first arched portion 202 and the second arched portion 206 of the platform 182 of the lifting frame 146 are disposed adjacent to a portion of the water heater 18. The water heater 18 is manually tilted in a direction opposite the portable apparatus 10 while the later is moved toward the water heater 18 so that a portion of the second end 214 of the water heater 18 can be rested on the supporting lips 218 of the platform 182, i.e., the water heater 18 is positioned such that the platform 182 is supporting at least one portion of the water heater 18.

The flexible band 190 of the strapping mechanism 186 is secured generally about at least a portion of the water heater 18 and is secured by the fastening end 194, which can be for example a hook, to the brace member 170 of the lifting frame 146. The tightening assembly 198, which can be also be connected to the brace member 170, can retract the flexible band 190 to secure the flexible band 190 about the water heater 18 and to secure the water heater 18 to at least a portion of the lifting frame 146, namely the platform 182. For example, if the tightening assembly 198 includes a ratchet tie down band clamp, a sprocket wheel of the ratchet tie down band clamp can be manually rotated in a conventional manner so that the flexible band 190 firmly impinges or secures the water heater 18 against the first arched portion 202 and the second arched portion 206 of the platform 182.

Thereafter the water heater 18 is moved with the portable apparatus 10 to a place for installation, for example by wheeling along the portable apparatus 10, and the water heater 18 supported by the portable apparatus 10, on the translation wheels 222 of the translation assembly 46 generally along the surface 48 to the installation location.

As shown for example in FIG. 6, if the water heater 18 supported by the portable apparatus 10 is to be installed in a location 266 which is elevated to the surface 48, such as for example on a stand, the water heater 18 can be lifted by the lifting assembly 28 of the portable apparatus 10. The hoist assembly 150 can retract the flexible belt 154 engaging the lifting frame 146 to cause the lifting frame 146 to traverse generally along at least a portion of the length 44 of the mast 24 toward the first end 36 of the mast 24. For example, if the hoist assembly 150 includes a hand crank winch 158, the hand crank winch 158 can be manually angularly rotated to wind the flexible belt 154 on a hoist drum 268 of the hand crank winch 158, to traverse the lifting frame 146 generally along the mast 25, and thus lift the water heater 18 to a desired elevated position. The water heater 18 is initially disposed with a portion of its second end 214 on or near at least a portion of the elevated installation location 266 to receive the water heater 18. The flexible band 190 is released, for example by unhooking the fastening end 194 and/or by advancing the flexible band 190 and removing the flexible band 190 from about the water heater 18. The water heater 18 is positioned at its permanent elevated installation location 266 and the portable apparatus 10 is moved away from the installation location 266, thus completing a normal cycle of operation of the portable apparatus 10.

FIG. 7 illustrates an alternative embodiment particularly useful for installing the water heater 18, for example the water heater 18, in an elevated installation location 266 which is located on an overhead surface 270 with an opening 274 therein which is above the surface 48, such for example a space above the ceiling of a conventional residential dwelling, such as in an attic of the residential dwelling. This embodiment of the portable apparatus 10 includes the extension member 124 telescopically disposed in elongated member 112 of the mast 24 such that the first end 36 of the mast 24 is positioned generally equal to or greater than the elevated installation location 266 so that the working length 44 available for the lifting frame 146 is such that the lifting assembly 28 is capable of lifting the water heater 18 through the opening 274 to the elevated installation location 266. The portable apparatus 10 includes the hoist post 158 and the hoist assembly 150 is connected to the hoist post 158.

To accomplish this, the extension member 124 telescopically disposed in the elongated member 112 is extended from the elongated member 112. One way of disposing the extension member 124 into the elongated member 112 is to remove the handle 230 from elongated member 112 of the mast 24, and providing the extension member 124 with a reduced end portion 300 which is telescopically received by the elongated member 112 opposite the base frame 20. The extension member 124 is connected to the elongated member 112, for example via a pair of spring urged pins (not shown) which engage the holes 132 normally receiving the handle 230 to lock the extension member 124 in axial alignment with the elongated member 112 of the mast 24. The hoist assembly 150 is moved from its normal position on the elongated member 112 of the mast 24 and is similarly connected to an upper end portion 308 of the extension member 124, thus permitting the flexible belt 154 of the hoist assembly 150 to traverse the lifting frame 146 so as to lift the water heater 18 to the desired elevated installation position 266.

Further, tilting of the mast 24 and water heater 18 by the tilting assembly 32 facilitates positioning the mast 24 through the opening 274, lifting the water heater 18, or other workload 14, through the opening 274, and/or installing the water heater 18, or other workload 14, in the desired elevated installation position 266.

The portable apparatus 10 may be folded, for shipping or storage, which is accomplished by manually rotating the screw 138 of the screw jack 134 of the tilting assembly 32 to tilt the mast 24 in a forward direction, as described hereinabove, until the mast 24 and any components supported thereby to be tilted toward a horizontal position until the mast 24 is substantially parallel with the longitudinal axis of the telescoping legs 64 of the base frame 20. Further, portions of the portable apparatus 10 can be disassembled to facilitate shipping or storage. For example, the elongated member 112, and any components supported thereby, can be removed from the foot portion 108 of the mast 24.

The embodiments of the invention discussed herein are intended to be illustrative and not limiting. Other embodiments of the invention will be obvious to those skilled in the art in view of the above disclosure. Changes may be made in the embodiments of the invention described herein, or in the parts or the elements of the embodiments described herein, or in the steps or sequence of steps of the methods described herein, without departing from the spirit and/or the scope of the invention as defined in the following claims.

What is claimed is:

1. A portable apparatus for moving a workload, comprising:
a base frame;
a translation assembly engaging the base frame to facilitate movement of the base frame;
a non-telescoping mast having a lower end pivotally engaging the base frame, an upper end, and a length extending between the lower end and the upper end;
a tilting assembly engaging the mast and the base frame to selectively adjust the incline of the mast relative to the base frame;
a lifting frame operatively associated with the mast; and,
a hoist assembly engaging the mast and the lifting frame for selectively lifting the lifting frame along at least a portion of the length of the mast.

2. The portable apparatus of claim 1, wherein the base frame has an expandable portion.

3. The portable apparatus of claim 2, wherein the expandable portion of the base frame comprises a telescoping cross-member and at least one leg connected to the telescoping cross-member such that the telescoping cross-member is selectively expanded to move the leg outward relative to the base frame.

4. The portable apparatus of claim 3, wherein the at least one leg connected to the telescoping cross-member comprises two legs connected to the telescoping cross member such that the telescoping cross-member is selectively expanded to move the two legs outward relative to one another and the base frame.

5. The portable apparatus of claim 3, wherein the at least one leg has at least one caster associated with the at least one leg such that the at least one caster is adapted to selectively cooperate with the translation assembly to facilitate movement of the portable apparatus.

6. The portable assembly of claim 3, wherein the telescoping cross-member comprises at least one spring biasing the at least one leg connected to the telescoping cross-member in an inward direction relative to the base frame.

7. The portable assembly of claim 3, wherein the telescoping cross-member comprises at least one spring biasing the at least one leg connected to the telescoping cross-member in an outward direction relative to the base frame.

8. The portable assembly of claim 1, wherein the mast has an elongated portion and a foot portion, wherein the elongated portion extends from the lower end to the upper end of the mast, and wherein the foot portion is rigidly disposed in angularly-spaced relation to the elongated portion.

9. The portable assembly of claim 8, wherein the tilting assembly engages the foot portion of the mast.

10. The portable assembly of claim 9, wherein the tilting assembly comprises a threaded screw jack threadingly engaging at least one of the base frame and the foot portion of the mast to selectively adjust the incline of the mast relative to the base frame.

11. The portable assembly of claim 8, wherein at least a portion of the elongated portion of the mast has a box-channel tubing construction.

12. The portable assembly of claim 1, wherein the mast has a plurality of holes formed in at least a portion of the mast.

13. The portable assembly of claim 1, wherein the hoist assembly adjustably engages the mast such that the hoist assembly is selectively positionable at any of a plurality of points along the length of the mast.

14. The portable assembly of claim 13, wherein the mast has a plurality of holes formed in at least a portion of the mast.

15. The portable assembly of claim 1, further comprising a holding assembly engaging the mast to selectively prevent the lifting assembly from traveling in at least one longitudinal direction along the length of the mast.

16. The portable assembly of claim 15, wherein the mast has a plurality of holes formed in at least a portion of the mast.

17. The portable assembly of claim 16, wherein the holding assembly comprises at least one pin selectively extending through at least one of the plurality of holes in at least a portion of the mast to prevent the lifting assembly from traveling in at least one longitudinal direction along the length of the mast.

18. The portable assembly of claim 1, wherein the hoist assembly comprises a winch having a flexible belt operatively associated with the lifting frame such that actuation of the winch in a first direction lifts the lifting frame along the length of the mast.

19. The portable assembly of claim 18, wherein the hoist assembly further comprises a roller rollingly engaging the flexible belt and disposed between the winch and the lifting frame.
